(19) United States
(12) Patent Application Publication
(10) Pub. No.: US 2015/0096349 A1
(43) Pub. Date: Apr. 9, 2015

(54) OPTIMIZE ANALYTE DYNAMIC RANGE IN GAS CHROMATOGRAPHY

(71) Applicant: PEN Inc., Deerfield Beach, FL (US)

(72) Inventor: Royce W. Johnson, Universal City, TX (US)

(21) Appl. No.: 14/399,420

(22) PCT Filed: Apr. 14, 2013
(86) PCT No.: PCT/US2013/040931

§ 371 Date: Nov. 6, 2014

Related U.S. Application Data
(60) Provisional application No. 61/646,435, filed on May 14, 2012.
(60) Provisional application No. 61/646,452, filed on May 14, 2012.

(51) Int. Cl. G01N 30/72; G01N 30/76; G01N 30/74

(52) U.S. Cl. CPC G01N 30/72; G01N 30/74; G01N 30/76
USPC 73/23.37; 73/23.4

(57) ABSTRACT

A non-specific gas analyzer with a wide dynamic range of concentration is used to assess the gas sample for total load of volatile organic constituents, and then control either a dilution with neutral gas or the quantity of sample aspirated in order to consistently deliver an appropriate total load of volatile analyte to a high-sensitivity analyzer. Such high-sensitivity analyzers may be gas chromatography combined with mass spectrometry or related mass spectrometry configurations, such as selected ion flow tube mass spectrometry, gas chromatography combined with ion mobility spectrometry, or related ion mobility configurations such as differential mobility spectrometry.

This application claims priority to U.S. Provisional Patent Applications Ser. Nos. 61/646,435 and 61/646,452, both of which are hereby incorporated by reference herein.

### BACKGROUND INFORMATION

Current methods for performing gas chromatography (“GC”) with hyphenated analysis of fractionated gas sample suffer from a limited range of concentration of the analytes of interest. Even highly sensitive analysis methods have a minimum limit of detection. However, too much analyte in the sample will saturate the instrument. While this is not often a problem under laboratory conditions, when these instruments are used under field conditions, the quantities of organic volatiles present in submitted gas samples can be highly variable and lead to overloading of the instrument. An overloaded high-sensitivity analyzer will yield useless analysis results and can require substantial effort to clear the compounds from the analyzer's pathways prior to any further analyses. Similarly, insufficient quantities of analytes lead to under-detection of potentially important features of the sample composition.

This problem arises because field conditions are only loosely controlled with respect to the concentration of background odors. For example in a hospital setting, odors from cleaning compounds, from other patient secretions, and even from hospital equipment such as bedding, are largely out of the control of the instrument operator.

The more sensitive the instrument, the more prone to overloading it becomes. This is particularly an issue with hyphenated methods employing a gas chromatograph column as the first analysis stage, due to the limited total load of analyte that a GC column can effectively separate.

In order to make highly sensitive gas analysis instrumentation viable under field conditions, this must be resolved.

### BRIEF DESCRIPTION OF THE DRAWINGS

FIG. 1 illustrates diluting a bulk gas sample to appropriate levels for analysis using a high-sensitivity analyzer with a fixed-volume of gas for analysis.

FIG. 2 illustrates adjusting gas sample volume to deliver correct total quantity of analytes for a variable-volume high-sensitivity analyzer.

FIG. 3 illustrates an infrared measurement scheme.

FIG. 4 illustrates a sampling controller in accordance with embodiments of the present invention.

### DETAILED DESCRIPTION

Aspects of the present invention use a non-specific gas analyzer or sensor with a wide dynamic range of concentration to assess the gas sample for total load of volatile organic constituents, and then control either a dilution with neutral gas or the quantity of sample aspirated in order to consistently deliver an appropriate total load of volatile analyte to the high-sensitivity analyzer. Such high-sensitivity analyzers may be GC combined, with mass spectrometry (“MS”) or related mass spectrometry configurations, such as selected ion flow tube mass spectrometry (“SIFT-MS”), GC combined with ion mobility spectrometry (“IMS”), or related ion mobility configurations such as differential mobility spectrometry (“DMS”) or even GC combined with GC or IMS or DMS combined with MS.

Another embodiment of this invention is for analytical techniques that use a concentrator or trap to amplify the gas signal.

The non-specific gas analyzer or sensor operates upstream of the high-sensitivity analyzer to ensure that the high-sensitivity analyzer is not over- or under-loaded with analytes.

A variety of non-specific gas analyzers or sensors could be used depending on the class of compounds sought. Sensor technologies should provide rapid results and be equally sensitive to all forms of analytes likely to be present in the sampled gasses, which will vary by the application undertaken. Breath samples, for example, are likely to be saturated with water vapor and have relatively high fractions of carbon dioxide, both of which may overload the analyzer. Field samples from an industrial or agricultural process are likely to be much drier and to contain a narrower range of analytes produced by the production processes being tested. Infrared transmissivity, acoustic resonance, photo-acoustic sensors, thermal conductivity, etc. are a few of the viable techniques to measure total gas constituent concentrations. Some ability to tune the sensor to the analyte classes most likely to cause problems or of most interest to detect will be helpful. If water vapor is a primary loading problem, infrared detection at 1100 nm will be the most effective. If organic alcohols are the principle target, then a photo-acoustic sensor tuned to respond to O—H and C—H bonds will be the most useful.

Embodiments of the non-specific gas analyzers or sensors utilize a photo-acoustic sensor. A photo-acoustic sensor is described in U.S. Published Patent Application No. 2012/0266653, which is hereby incorporated by reference herein. An advantage of a photo-acoustic sensor is that it can sense a wide range of gasses.

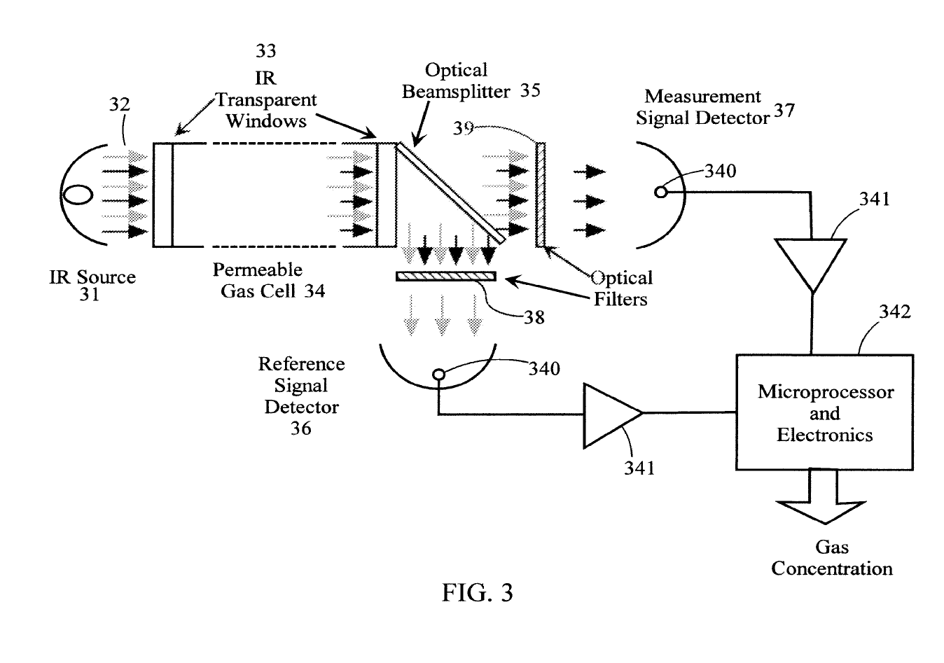

Embodiments of the non-specific gas analyzers or sensors utilize an infrared gas sensor. These sensors tend to be specific for a particular gas. Common gases that can be detected by IR sensors include, but are not limited to, Butane, Carbon Dioxide, Ethane, Ethanol, Ethylene, Ethylene Oxide, Hexane, Methane, Methyl Bromide, Nitrous Oxide, Pentane, Propane, and Propylene (Propene). FIG. 3 shows how a well-known infrared gas sensor functions. Their mode of operation can be briefly described as follows: an infrared (“IR”) source 31 illuminates a volume of gas that has entered inside the measurement chamber with infrared light 32. The measurement gas chamber 34 allows gas to flow through the chamber (a kind of permeable gas cell). Infrared transparent windows 33 on both ends of the measurement chamber 34 allow the infrared light to enter and exit the gas measurement chamber and help define the volume of the measurement chamber 34 and the distance that the infrared light 32 passes. The gas in the measurement chamber 34 absorbs some of the infrared wavelengths as the light passes through it, while others pass through it completely unattenuated. The amount of absorption is related to the concentration and chemistry of the gas, since some gas analytes absorb at certain frequencies of infrared light and other gas species absorb at other frequencies. The infrared light that exits the measurement chamber 34 is divided by an optical beamsplitter 35 and sent along two different paths. One path goes to a reference signal detector 36 and one path goes to a measurement signal detector 37. Light that goes into the reference signal detector 36 first passes through a reference signal optical filter 38 that takes out all light that would be also absorbed or modulated by the analyte gas of interest in the measurement chamber. Light that goes into the measurement signal detector 37 also passes through an optical filter 39 that is in front of the measurement signal detector 37. This optical filter 39 is designed to allow light that is modulated by the analyte gas of interest to pass through to the detector and be measured and other wavelengths of light are blocked. Thus it is important that the optical filters between the two detectors allow different frequencies (or wavelengths) of light to pass. Suitable electronic systems include detectors 340 that turn a light signal to an electrical signal, amplifiers 341 that amplify the electrical signal and a microprocessor 342 or suitable electronics and software algorithms not shown) that measure the relative intensities of the light from both paths and calculate a gas concentration. The change in the intensity of the absorbed light is measured relative to the intensity of light at a non-absorbed wavelength. The microprocessor 342 computes and reports the gas concentration from the absorption.

When there is no gas present, the signals of reference signal detector 36 and measurement signal detector 37 are balanced. When there is an analyte gas present, there is a predictable drop in the output from measurement signal detector 37, because the gas is absorbing light.

With either embodiment described, the non-specific gas analyzer or sensor in accordance with embodiments of the present invention may be configured to measure total humidity or analytes that may be comprised in part of oxygen-hydrogen (“O—H”) bonds by careful selection of the optical filters used. Another choice of optical filters may allow one to measure analyte gases that may be comprised in part of carbon-hydrogen single (“C—H”) bonds, or another choice may allow one to measure analyte gases that may be comprised in part of carbon-carbon single (“C—C”), double (“C═C”), or triple (“C≡C”) bonds and so forth.

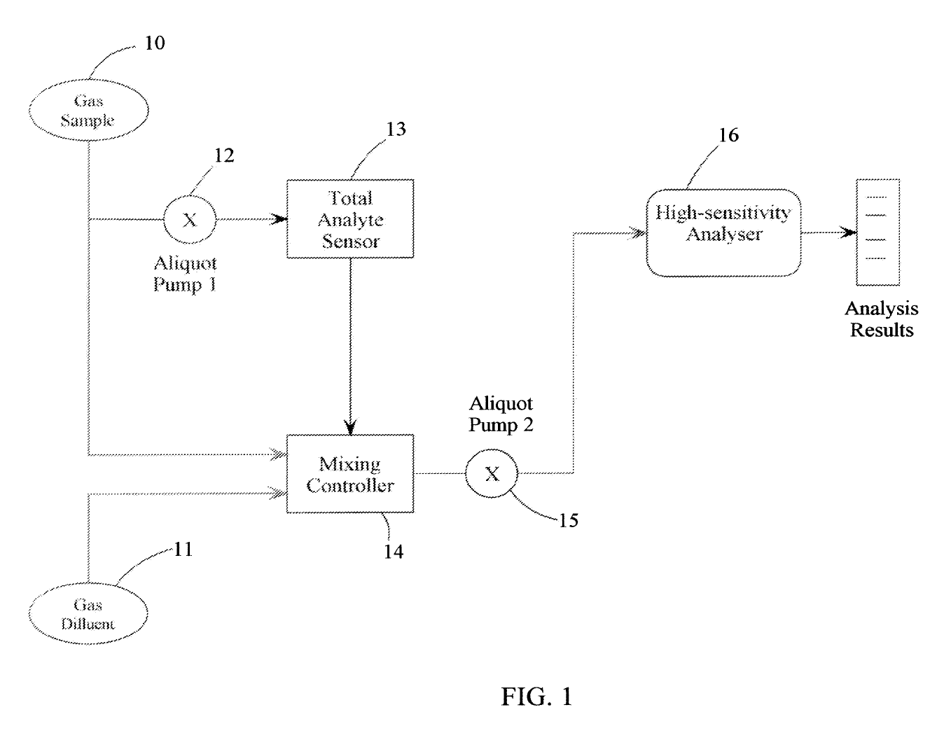

Referring to FIG. 1, when the non-specific gas analyzer or sensor (hereinafter, the non-specific gas analyzer or sensor may be referred to as the “total analyte sensor”) levels have been determined, the sample may be diluted with purified carrier gas (e.g., synthetic air) to reduce the total load of a fixed sample to analyte levels that can be accurately processed by the high-sensitivity analyzer. This approach may he required for any high-sensitivity analyzer technology that requires a fixed volume of sample. The aliquot pump 12 withdraws a small portion of the available gas sample and delivers it to the total analyte sensor 13 to determine the total concentration of analytes in the bulk gas sample or total concentration of chemicals that are comprised of one or more specific chemical bonds or functional groups (e.g., O—H, C—H, C—C, etc.). The aliquot pump 12 may be manually operated or it may be controlled by a microprocessor (not shown) that defines the length of time that the aliquot pump 12 withdraws a gas sample. The microprocessor can be programmed from a user interface to operate for a prescribed amount of time that is determined by an operator or from an algorithm that may learn from previous trials and adjust the amount of sampling time in response to feedback from the high-sensitivity analyzer 16 or the total analyte sensor 13. Information from the total analyte sensor 13 is then used to calculate the appropriate dilution of the gas to meet input requirements of the high-sensitivity analyzer 16. As an example, through experience or experimentation, it may be found that concentrations above a certain level as measured by the total analyte sensor 13 will saturate the high-sensitivity analyzer 16 or in some way cause a false reading. Thus the operator could establish an upper limit of what concentration is allowed into the high-sensitivity analyzer 16 and the microprocessor, through appropriate operating software, calculates a dilution factor such that the concentration upper limit allowed into the high-sensitivity analyzer 16 is maintained. These upper concentration levels could vary from instrument to instrument or instrument type of the high-sensitivity analyzer. The dilution required is performed in a gas mixing chamber 14 and a fixed volume of the diluted sample is sent to the high-sensitivity analyzer 16.

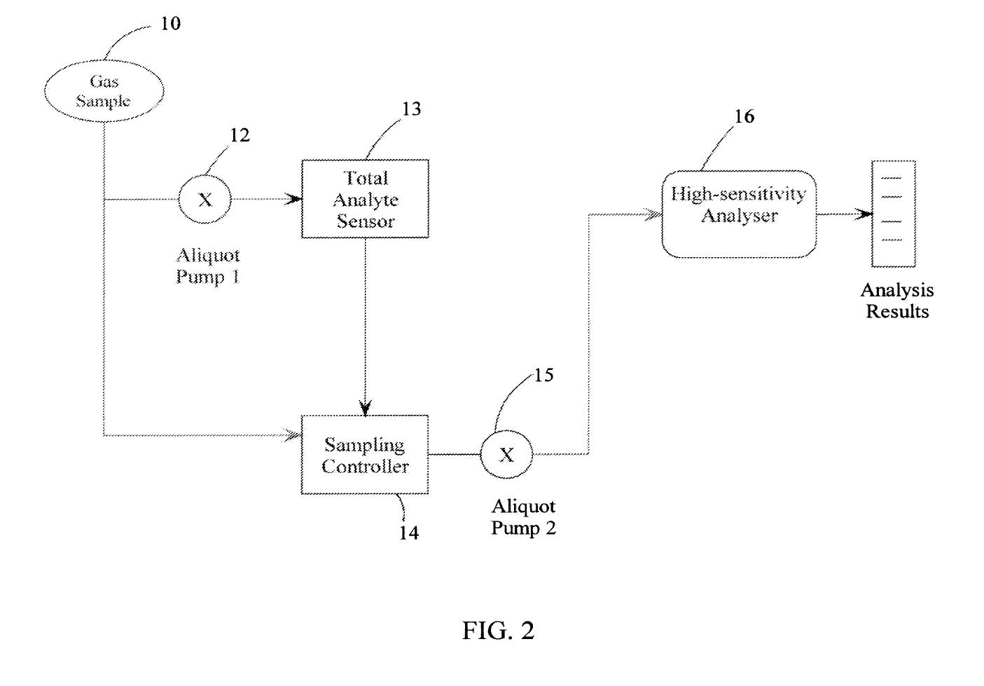

Referring to FIG. 2, for high-sensitivity analyzers that do not require fixed-volume samples, an alternative response may be to adjust the amount of gas sample supplied to the high-sensitivity analyzer 16, reducing the amount even of high levels of analytes. In this approach, the volume of gas to be delivered to the high-sensitivity analyzer 16 may be determined by the total analyte sensor 13 using a small portion of the available gas sample as supplied through the pump 12. If the total analyte load is high, as measured by the total analyte sensor 13, the volume delivered, as metered out by the aliquot pump 15 to the high-sensitivity analyzer 16 will be reduced. If the total analyte load is low, as measured by the total analyte sensor 13, then the delivered volume of aliquot pump 15 will be increased. The sampling controller 14 then delivers an optimal amount of gas to the high-sensitivity analyzer 16 to ensure maximal accuracy and sensitivity.

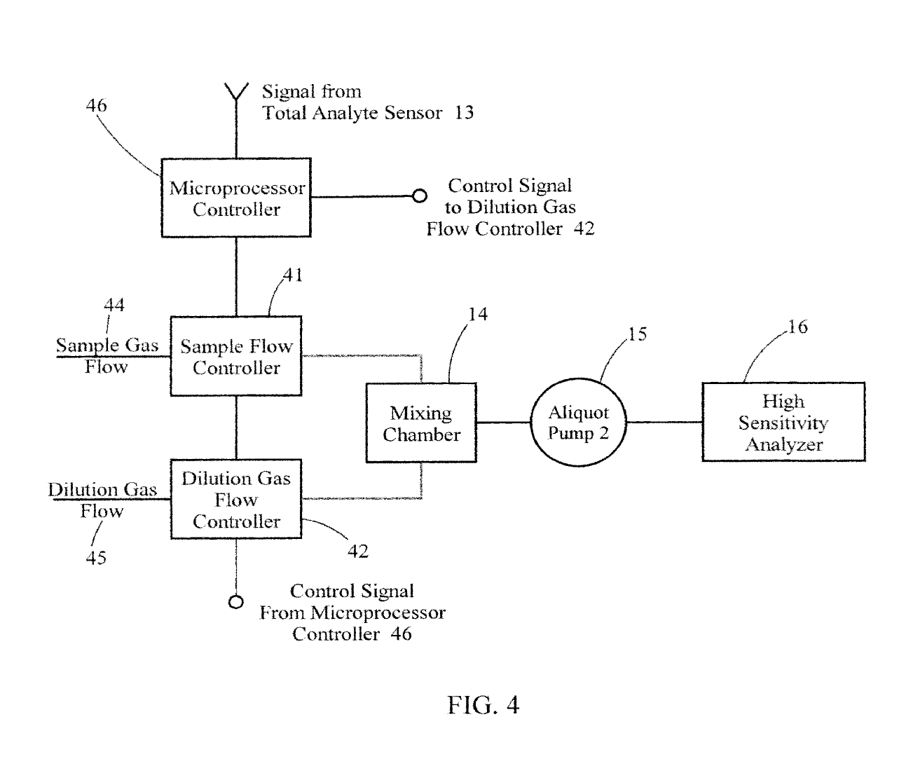

FIG. 4 illustrates an embodiment of the present invention what implements a sampling and/or mixing controller 14. Sample gas flow 44, receiving gas from gas sample 10, and dilution gas flow 45, receiving gas from gas diluent 11, may be controlled by the sample flow controller 41 and dilution flow controller 42, respectively. The sample flow controller 41 and dilution gas flow controller 42 receive control signals from the microprocessor controller 46 that reacts to concentration levels measured by the total analyte sensor 13 and/or inputs from a user interface (operator input), or feedback from the high-sensitivity analyzer 16 that establish a dilution factor such that the flows into the mixing chamber 14 achieve concentration levels below a predetermined upper level or at a predetermined optimal level. An aliquot pump 15 controls volume of mixed or diluted gas that is allowed into the high-sensitivity analyzer 16.

Any similar analysis techniques with limited working range of analyte concentrations may benefit from this invention. DNA matrix, chips, flow injection analysis, gel electrophoresis, HPLC, atomic absorption spectrometry, etc. are methods that operate with most accuracy in a limited window of analyte concentrations. Embodiments of the present invention may be adopted to any of these, simply by shifting from gas sampling mechanisms to liquid sampling mechanisms and using an appropriate measurement of total analyte loading.

High-sensitivity gas analyzers operate within limited ranges of total analytes allowable in the sample for analysis. Aspects of the present invention adjust the total quantity of analyte presented to the high-sensitivity analyzer to ensure maximal performance of that analyzer. Aspects of the present invention rely on a pre-sensor capable of determining total analyte concentration in the bulk sample and capable of controlling a mixing- or sampling-controller to deliver either diluted or limited-volume samples to the high-sensitivity analyzer.

What is claimed is:

1. A gas analyzer apparatus comprising:
a non-specific gas analyzer or sensor suitable for receiving a gas sample containing a volatile analyte to be measured;
a high-sensitivity gas analyzer; and
a mixing controller coupled to the non-specific gas analyzer or sensor and suitable for delivering an appropriate total load of volatile analyte to the high-sensitivity analyzer.

2. The apparatus as recited in claim 1, wherein the mixing controller is suitable for mixing the gas sample with a gas diluent for delivery to the high-sensitivity analyzer.

3. The apparatus as recited in claim 1, wherein the non-specific gas analyzer is a photo-acoustic sensor.

4. The apparatus as recited in claim 1, wherein the non-specific gas analyzer is an infrared gas sensor.

5. The apparatus as recited in claim 1, wherein the high-sensitivity gas analyzer is a gas chromatography combined with ion mobility spectrometry configuration.

6. The apparatus as recited in claim 1, wherein the high-sensitivity gas analyzer is a gas chromatography combined with differential mobility spectrometry configuration.

7. The apparatus as recited in claim 1, wherein the high-sensitivity gas analyzer is a selected ion flow tube mass spectrometry configuration.

8. The apparatus as recited in claim 1, further comprising circuitry suitable for delivering the appropriate total load of volatile analyte to the high-sensitivity analyzer as a function of a signal from the non-specific gas analyzer or sensor.

9. The apparatus as recited in claim 1, wherein the signal from the non-specific gas analyzer or sensor is an indication that the gas sample is loaded with volatile analytes greater than a predetermined threshold volume loading.
